(19) United States
(12) Patent Application Publication
(10) Pub. No.: US 2001/0038094 A1
(43) Pub. Date: Nov. 8, 2001

(54) Adjustable size aircraft wheel lifting cart using squeeze-action dual-angled roller arms

(75) Inventors: Donald Eugene Lundy SR., El Cajon, CA (US); Donald Eugene Lundy JR., Alpine, CA (US)

Correspondence Address: D. Eugene Lundy, I, ExexAir Maintenance, 3225 N. Harbor Drive, Suite 101, San Diego, CA, 92101, US

(73) Assignee: Execair Maintenance Inc.

(21) Appl. No.: 09/565,121

(22) Filed: May 4, 2000

(51) Int. Cl. B60B 29/00

(52) U.S. Cl. 254/1; 414/429

(57) ABSTRACT

A portable, compact cart easily lifts and maneuvers heavy vehicle wheels for removal, repair, transportation, and the like. The cart includes a U-shaped bracket with opposing arms slidably interconnected along a straight center section. In addition to wheels beneath the cart, rollers are mounted atop the arms. For example, each arm may include a paired set of rollers forming a V-shape when viewed from the cart's top or end. When an upright wheel is cradled by opposing arms, the rollers help keep the wheel upright. A user-activated push/pull assembly is attached to both arms to slidably lengthen and shorten the center section, thereby drawing the arms together (lifting the wheel) or spreading the arms apart (releasing the wheel). The push/pull assembly may use a lever whose distal end is pivotally coupled to one of the arms along the straight center section. In this example, a connecting rod is pivotally coupled to the other arm along the straight center section, and also coupled to the lever outwardly from the proximal end. Although the slidable center section accommodates wheels of various sizes, the connecting rod may also have adjustable length, to ensure that the lever forms a sufficiently small angle with the bracket to generate maximum force when the weight of the wheel is being lifted by the rollers.

### BACKGROUND OF THE INVENTION

1. Field of the Invention

The subject invention relates to the field of jacks, lifts, and similar apparatuses for lifting heavy equipment. More particularly, the invention concerns a new type of cart for lifting and supporting large wheels (such as airplane wheels) while in a vertical position. Because the cart itself is wheeled, the user can easily rotate and transport the lifted wheel while it is supported by the cart.

2. Description of the Related Art

Airline travel is more popular today then ever. Airlines are purchasing more and larger jet airplanes to serve an increasing number of passengers. With the increasing level of traffic comes an increasing maintenance workload. As for annual inspections and other planned maintenance, airlines account for such maintenance in advance and schedule the airplanes' locations and down times accordingly. Despite the best planning, unpredicted maintenance unavoidably becomes necessary due to component malfunctions, normal wear and tear, damage, etc. When this occurs, with airplane passengers waiting, time is of the essence.

One common maintenance operation that is often required without notice is the removal and replacement of an airplane wheel. Airplane wheels must be removed, for example, to change a tire that is damaged or worn, repair wheel brakes, perform work on landing gear, etc. Unlike automobile wheels, aircraft wheels are much more heavy, bulky, and unwieldy. Therefore, most airplane mechanics today use hydraulic lifts to remove and replace aircraft wheels.

The most popular device for this purpose utilizes a dolly with a pair of parallel bars attached at one end to the hydraulic lifting mechanism. The dolly is maneuvered so that the bars' outstretched, open ends protrude under the aircraft tire. Then, someone moves a jack handle back and forth to activate the hydraulic jack, which begins to cradle the tire across the bars is the bars start to rise. Several other people must be present to hold the heavy wheel upright during this process because the wheel can be quite wobbly. In this respect, the wheel may also be strapped to the dolly using fabric straps, chains, etc.

Although the foregoing device is quite popular in the field, the present inventors have recognized a number of limitations. For one, the fixed distance, parallel bars are unable to accommodate different sizes of tires. Therefore, maintenance operators must purchase one lift for large wheels, such as a McDonnel Douglas MD-80 main wheel tire, and another lift for nosewheels or wheels of smaller airplanes. Also, use of the conventional lifts is demanding in terms of manpower because of the need for several people to steady the wheel being lifted, and because of the time consuming process required to operate the hydraulic jack. The wheel's tendency to fall over during lifting also presents a safety concern.

Consequently, known aircraft wheel lifting devices are not completely adequate for some applications due to certain unsolved problems.

### SUMMARY OF THE INVENTION

Broadly, the present invention concerns a new type of cart for lifting and supporting airplane and other large wheels while in a vertical position. The cart includes a U-shaped bracket with opposing, largely parallel arms slidably interconnected along a straight center section. In addition to wheels beneath the cart, rollers are mounted atop the arms. For example, each arm may include a paired set of rollers forming a V-shape when viewed from overhead the cart (and also forming a V-shape when viewed from either end of the cart). When an upright wheel is cradled by opposing arms, the rollers help keep the wheel upright. A user-activated push/pull assembly is attached to both arms to slidably lengthen and shorten the center section, thereby drawing the arms together (lifting the wheel) or spreading the arms (releasing the wheel). The push/pull assembly may use a lever whose proximal end is pivotally coupled to one of the arms along the straight center section. In this example, a connecting rod is pivotally coupled to the other arm along the straight center section, and also coupled to the lever outwardly from the proximal end. Although the slidable center section accommodates tires of various sizes, the connecting rod may also have adjustable length, to ensure that the lever forms a sufficiently small angle with the bracket to generate maximum force when the weight of the wheel is being lifted by the rollers.

The foregoing features may be implemented in a number of different forms. For example, the invention may be implemented to provide a method to lift a wheel or tire. In another embodiment, the invention may be implemented to provide an apparatus for lifting wheels, tires, and the like.

The invention affords its users with a number of distinct advantages. For example, the present invention's lifting apparatus helps workers lift large wheels, such as aircraft tires, while avoiding back and muscle injuries. This is possible because the invention lifts and supports large, heavy wheels using the advantage of leverage. By adjusting the cart's connecting rod, the user can ensure that the lever arm forms a small angle to the telescoping center section, thereby applying greatest force when the lever arm is operated. The cart is also easy to move in any direction because it rests on casters, rollers, or other wheels. In contrast to past arrangements, requiring a team of workers to remove and replace a wheel from a large aircraft, the present invention enables one or two people to do the same job. This is possible, in part, because the wheel lifting apparatus of this invention includes roller assemblies that are specially canted to automatically hold wheels in upright position, without the need for additional chains, straps, or workers.

Beneficially the cart is small and portable, it can even be carried aboard an aircraft's “fly kit.” As another benefit, the cart can be used on many different sizes of wheels because the connecting rod's length and attachment are adjustable. Moreover, the squeezing action of the cart's arms accommodates a variety different wheel sizes, even at one adjustment setting of the push/pull assembly. The invention also provides a number of other advantages and benefits, which should be apparent from the following description of the invention.

### BRIEF DESCRIPTION OF THE DRAWINGS

FIG. 1 is a perspective view of a wheel lifting apparatus of the invention, shown in a closed position.

FIG. 2 is a first side view of the wheel lifting apparatus of the invention, shown in a closed position.

FIG. 3 is a first end view of the wheel lifting apparatus of the invention, shown in a closed position.

FIG. 4 is a second side view of the wheel lifting apparatus of the invention, shown in a closed position.

FIG. 5 is a second end view of the wheel lifting apparatus of the invention, with the lifting apparatus in a closed position.

FIG. 6 is a top plan view of the wheel lifting apparatus of the invention, shown in a closed position.

FIG. 7 is a bottom plan view of the wheel lifting apparatus of the invention, shown in a closed position.

FIG. 8 is a perspective view of the wheel lifting apparatus of the invention, shown in an open position.

FIG. 9 is the first side view of the wheel lifting apparatus of the invention, shown in an open position.

FIG. 10 is a flowchart depicting an operating sequence for utilizing the wheel lifting apparatus of the invention.

FIG. 11 is the a side view depicting the wheel lifting apparatus of the invention before or after lifting a wheel.

FIG. 12 is a first side view depicting the wheel lifting apparatus of the invention while supporting a wheel.

FIG. 13 is a perspective view depicting the wheel lifting apparatus of the invention while supporting a wheel.

FIG. 14 is a perspective view of a roller with a concave rolling surface, according to the invention.

### DETAILED DESCRIPTION

The nature, objectives, and advantages of the invention will become more apparent to those skilled in the art after considering the following detailed description in connection with the accompanying drawings.

### Hardward Components & Interconnections

### Introduction

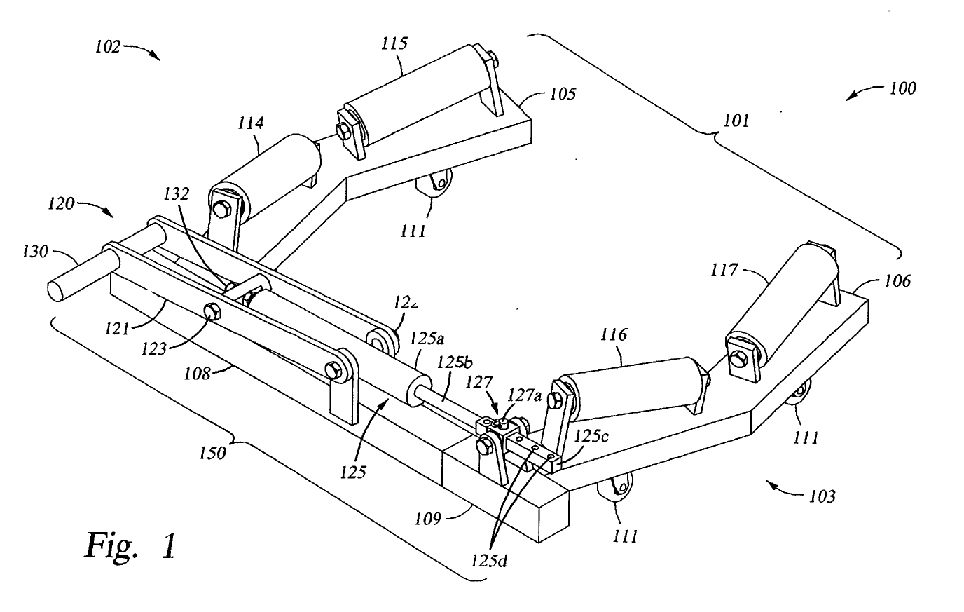

One aspect of the present invention concerns an apparatus for lifting tires, wheels, and the like. Although this apparatus may be embodied by various hardware components and interconnections, one specific example is embodied by the cart 100 shown in FIGS. 1-9. Referring to FIG. 1, the cart 100 includes a substantially U-shaped cradle 101 or “bracket,” which includes opposing arms 105, 106. The arms are interconnected in a way that permits the arms to move toward each other or away from each other, while remaining substantially parallel. As an example, such interconnection may involve a telescoping coupling or other appropriate connection that permits slidable inward/outward movement of the arms.

In the present example, the U-shaped cradle 101 includes a substantially straight center section 150 with a telescoping feature. Namely, the center section 150 includes a first sliding member 108 attached to the arm 105, and a second sliding member 109 attached to the arm 106. Part of the second sliding member 109 is hidden from view in FIG. 1 because it resides inside the first sliding member 108. Each arm attached to its respective sliding member thus forms a C-shaped member, illustrated by the C-shaped members 102,103.

### Wheels

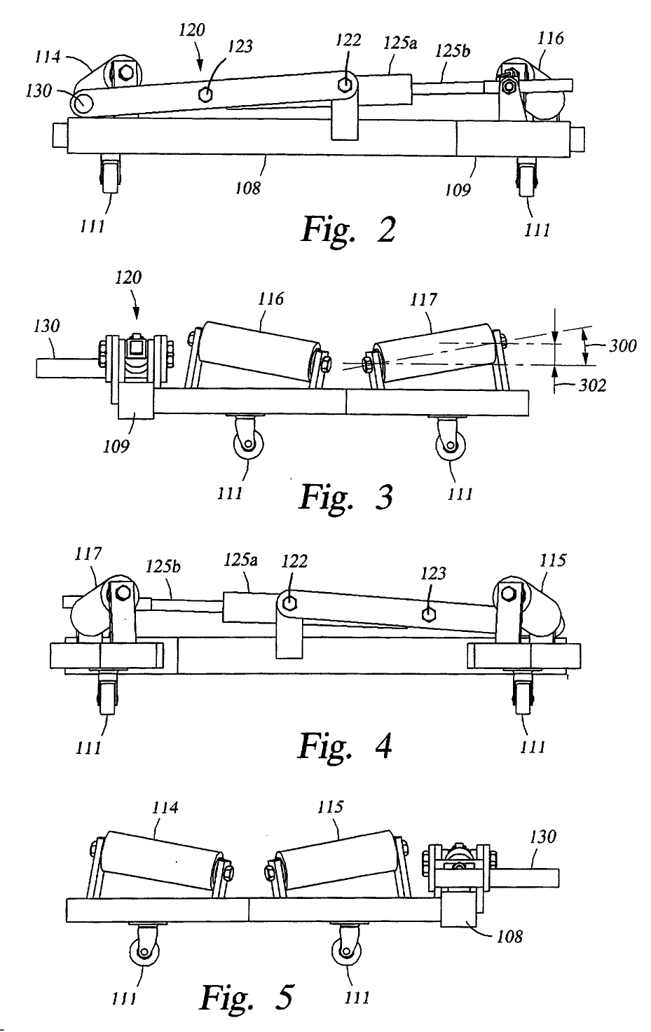

The cart 100 is supported by cart wheels 11 1, which are attached to a lower surface of the arms 105-106. In addition to FIG. 1, the cart wheels 111 also appear in FIGS. 2-5 and 7. The cart wheels 111 may be embodied by wheels, casters, rollers, or any other appropriate devices to support the cradle 101 upon a support surface (such as a runway, floor, asphalt ramp, concrete tarmac, the earth, indoor floor, etc.) and permit movement of the cart 100 across that surface. In this respect, some or all of the cart wheels 111 may include a castering or other rotatable feature to ease movement of the cart 100 in the desired direction. At least two cart wheels 111 (one under each arm 105, 106) are located beneath the arms to support the weight of the object being lifted by the cart 100. Other wheels may be located beneath the arms 105, 106 (as shown), and/or beneath the center section 150.

### Roller Assemblies

One or more rollers are mounted to each arm. The rollers of a particular arm are arranged so as to provide a curved receiving surface that cradles the rounded tread of an upright aircraft tire that is positioned between the arms 105-106. In the example of FIG. 1, the arm 105 includes two rollers 114-115, and the arm 106 includes two rollers 116-117. The design of two rollers per arm (as shown) provides straightforward construction while maintaining the beneficially curved receiving surface to accommodate a rounded-tread tire between the arms 105-106.

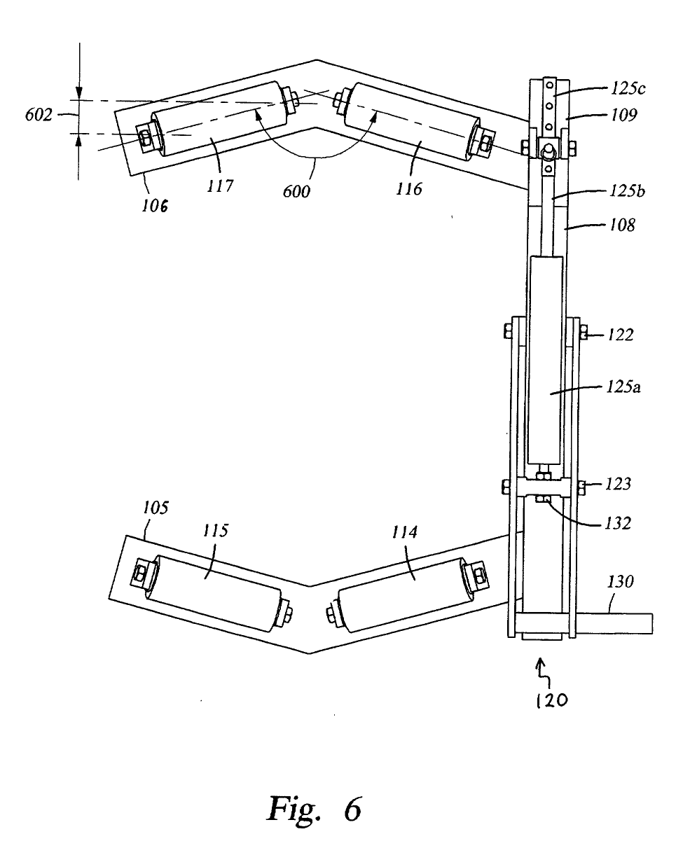

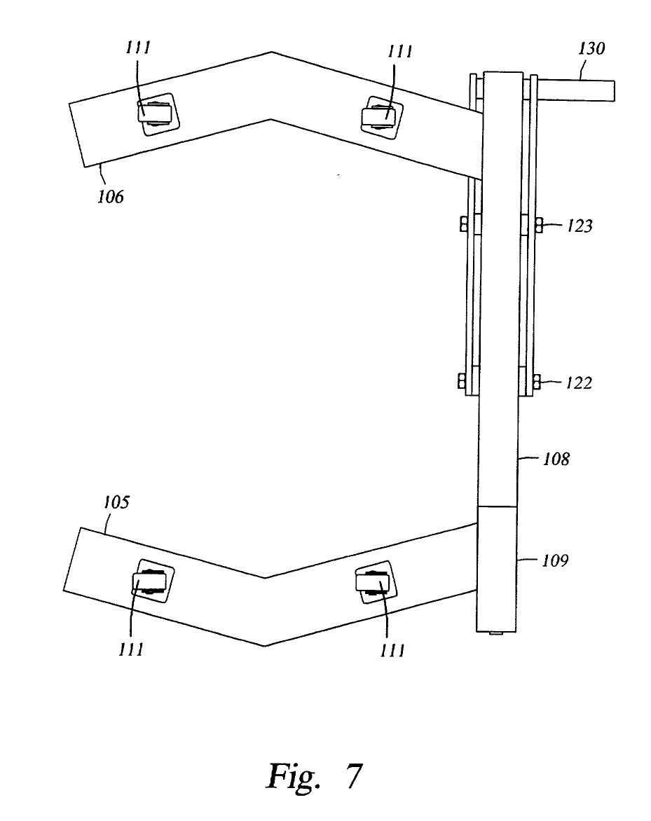

To provide this curved surface, the rollers of each arm are canted relative to each other. Namely, the outward ends of both rollers are elevated and shifted slightly toward the opposing arm. To provide a more specific illustration, FIG. 3 shows an end view of the rollers 116-117. Each roller's outboard end is elevated with respect to its inboard end, by the distance 302. This has the effect of vertically canting the roller by an angle 300. The shifting of the rollers outboard ends toward the opposing arm is more clearly shown in FIG. 6, depicting a top plan view of the cart 100. Each roller's outboard end is shifted toward the opposing arm with respect to its inboard end by the distance 602. This has the effect of horizontally canting the rollers to provide an angle 600 less than one-hundred-eighty degrees.

Thus, in the illustrated example, each pair of rollers on one arm forms a “V” shape when viewed from the top or end. The foregoing canting function may be implemented with three, four, or even more rollers, as well. As one example, two rollers may be substituted for each illustrated roller, thus providing four rollers instead of two. As another example, a series of any desired number of rollers may be substituted for the two illustrated rollers per arm. In this embodiment, each roller is elevated successively more than its inboard neighbor and also positioned nearer to the opposing arm that the inboard neighbor.

As another option, a single roller may be used upon each arm, where this roller presents a concave rolling surface extending along some or all of the length of the roller's respective arm. An example appears in FIG. 14, as shown by the roller 1400. Push/Pull Assembly

A push/pull assembly 120 dictates the positions of the members 102, 103 relative to each other. Namely, the push/pull assembly is user-activated to slidably lengthen and shorten the center section 150, thereby moving the arms apart or together.

As illustrated, the push/pull assembly 120 includes a lever arm 121 with one end pivotally coupled to one member of the center section, and a mid-point coupled to the other member of the center section. More particularly, the lever arm 121 has a distal end mounted to the first sliding member 108 at a first pivot point 122. The lever arm 121 includes a handle 130. The lever arm 121 is attached to the second sliding member 109 via a connecting rod 125, which attaches to the lever arm 121 at a third pivot point 123. The connecting rod 125 is attached to the sliding member 109 at a joint 127.

The connecting rod 125 includes first and second shafts 125a, 125b that are threaded together. The first shaft 125a is rotatable about an axial joint 132. The coupling between the second shaft 125b and the joint 127 prevents the shaft 125b from rotating in such a manner. Thus, when the first shaft 125a is rotated about the joint 132, this motion further threads the shaft 125b into the shaft 125a (one direction of rotation) or threads the shaft 125b out of the shaft 125a (other direction of rotation). Rotation of the shaft 125a thereby adjusts the overall length of the shafts 125a, 125b. Since the first shaft 125a is coupled to the member 108 with the second shaft 125b being coupled to the member 109, adjustment of the overall length of the shafts 125a, 125b changes the relative positions of the sliding members 108-109, therefore adjusting the length of the telescoping center section 150. Rotation of the shaft 125a constitutes “fine tuning” of the center section's length.

For courser adjustment, the user can adjust the site of attaching the shaft 125b to the joint 127. Namely, the shaft 125b includes an end section 125c with various holes 125d defined therein. After a pin 127a is removed from the joint 127, the shaft 125b is adjusted as desired with respect to the joint 127, and the pin 127a is reinserted.

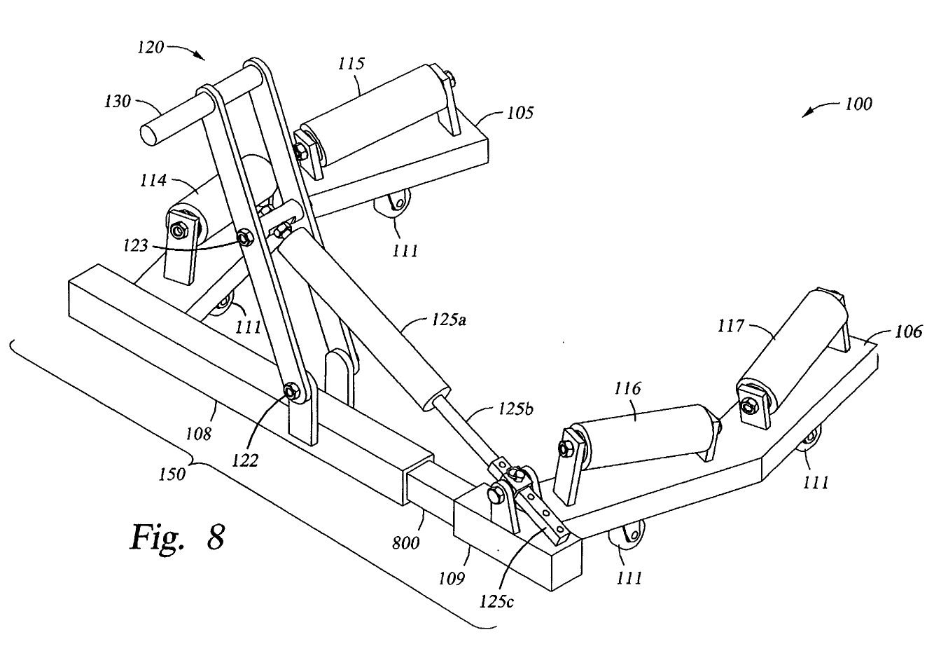

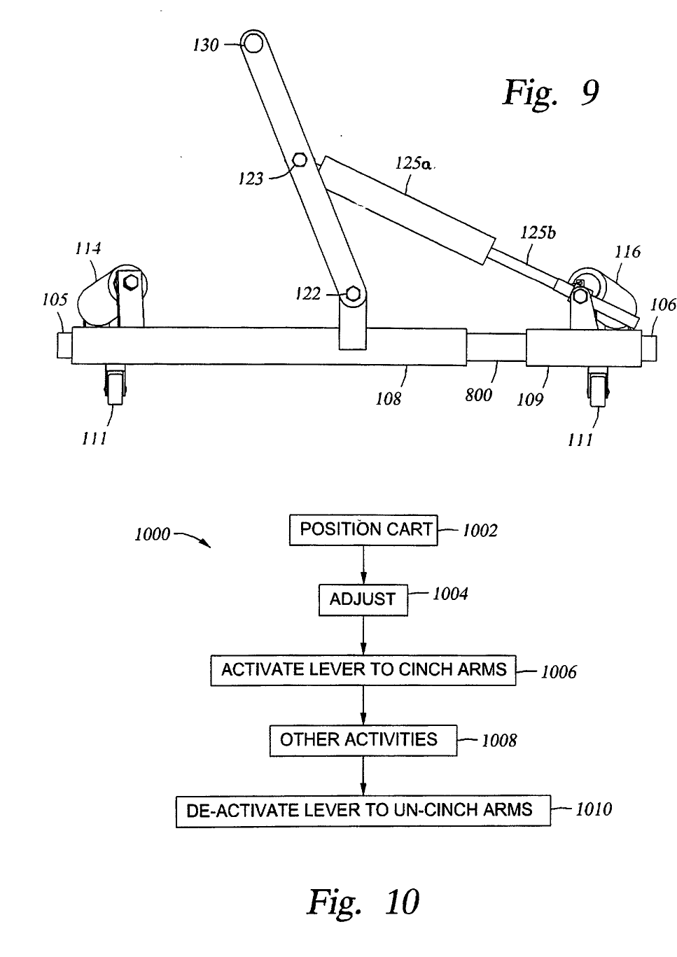

The user operates the push/pull assembly 120 as follows. With the cart 100 in a “closed” position (arms 105,106 together as far as they will go, as shown in FIGS. 1-7), the user grasps the handle 130 and lifts it upward. This places the cart 100 in its “open” position, as shown by FIGS. 8-9. Lifting the lever arm 121 upward causes the members 108,109 to slide apart; as shown in FIGS. 8-9, this action exposes a portion 800 of the member 109 that was previously hidden inside the member 108. With the cart 100 in this open position, the user can grasp the handle 130 again and press downward to urge the cart 100 back into its closed position.

### Operation

In addition to the various hardware embodiments described above, a different aspect of the invention concerns a method for utilizing the lifting apparatus of the invention. FIG. 10 shows a sequence 1000 to illustrate one example of this method. For ease of explanation, but without any intended limitation, the example of FIG. 10 is described in the context of the cart 100 described above. The operations 1000 are initiated in step 1002, when the user positions the cart 100 about a large wheel to be lifted or let down. The wheel is in an “upright” position, in that its axis of rotation is generally parallel to the ground. If the wheel is about to be lifted, it may constitute a replacement for another wheel with a flat tire, brake problem, etc. In this case, the purpose of lifting the wheel may be to lift the wheel sufficiently to mount it to the aircraft or other vehicle. If wheel is about to be let down, it may be presently mounted to its respective vehicle, but suffering from a flat tire, brake problem, etc. Due to the weight of this large wheel, it may be awkward, dangerous, or nearly impossible to remove or install the wheel by hand.

In step 1002, then, the user positions the arms 105-106 on opposite sides of the wheel. At this time, the cart 100 is open, and appears as shown in FIGS. 8-9. Here, each arm faces the tread on an opposite side of the wheel. In step 1004, the user adjusts the length of the center section 150. For especially strong lifting efficiency, one option is to adjust the center section 150 (sliding the sections 108,109 together or apart) so that the rollers 114-117 touch the wheel when the lever 121 makes an angle of about forty-five degrees with respect to the center section 150. The length of the center section 150 is adjusted by choosing the desired combination of pin 127a and hole 125d (course adjustment) and twisting the shaft 125a about the shaft 125b (fine adjustment).

After step 1004, the user activates the push/pull assembly to cinch the arms 105-106 together. Namely, the user presses fully downward upon the lever arm 121. If desired, the pivot point 122 may be sufficiently elevated from the center section 150 so that full downward deflection of the handle 130 places the pivot point 123 nearer to the center section 150. This eccentric position helps hold the lever arm 121 in its downward position. At this point, if the length of the center section 150 has been adjusted correctly, the rollers 114-117 support the weight of the wheel, as shown in FIGS. 12,13.

Next, the user performs other activities (step 1008) related to the operation at hand. For example, the user may transport the now-lifted wheel over to a vehicle by rolling the cart 100 on its cart wheels 111, and then proceed to align the wheel with the vehicle's axle or other mounting. In a different situation, if the wheel is already mounted to a vehicle, the user may take advantage of the wheel's lifted state to remove it from the vehicle.

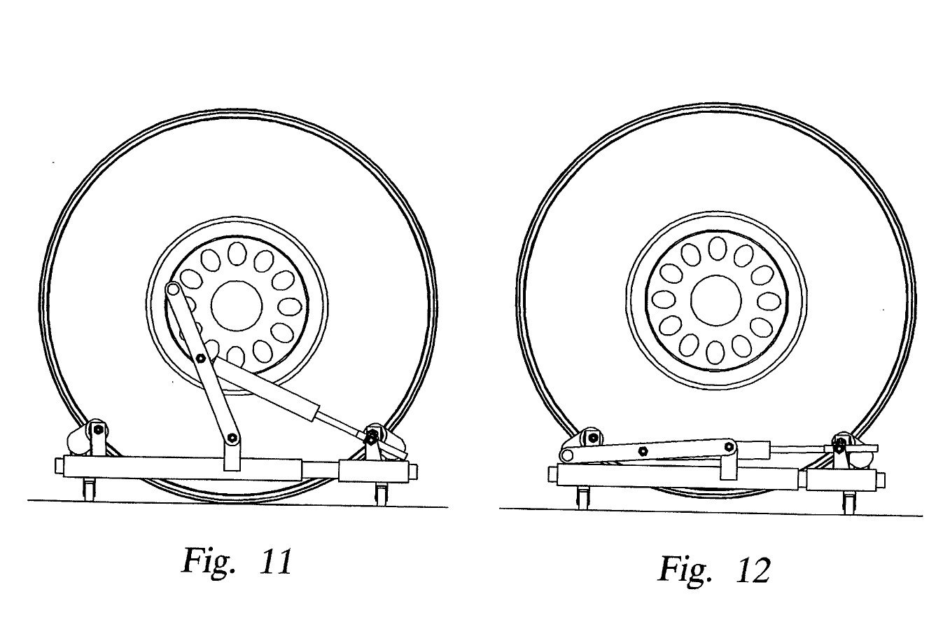

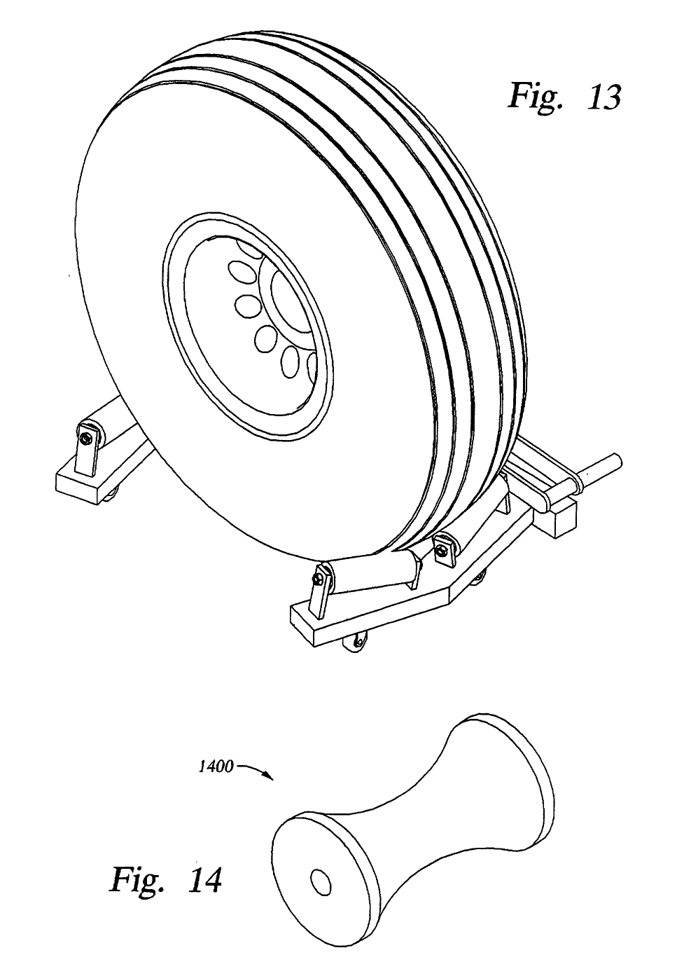

After step 1008, the user activates the push/pull assembly to spread the arms 105-106 apart (step 1010). If the wheel was mounted to a vehicle in step 1008, then step 1010 is performed by the user pulling upward on the lever arm 121 until the arms 105-106 are sufficiently spread apart to permit removal of the cart 100 from the wheel, while the wheel is supported by its mounting to the vehicle. If the wheel was removed from the vehicle in step 1008, then the user in step 1010 pulls upward upon the lever arm 121 until the wheel reaches the ground, floor, or other resting surface, as shown in FIG. 11. Then, with the wheel solidly lowered to the ground, the user can roll the cart 100 away from the wheel.

### Other Embodiments

While the foregoing disclosure shows a number of illustrative embodiments of the invention, it will be apparent to those skilled in the art that various changes and modifications can be made herein without departing from the scope of the invention as defined by the appended claims. Furthermore, although elements of the invention may be described or claimed in the singular, the plural is contemplated unless limitation to the singular is explicitly stated. Additionally, ordinarily skilled artisans will recognize that operational sequences must be set forth in some specific order for the purpose of explanation and claiming, but the present invention contemplates various changes beyond such specific order.

What is claimed is:

1. A method of lifting a wheel, comprising operations of:
placing opposing arms of a substantially U-shaped bracket beneath an upright wheel on opposite sides thereof such that each arm is transverse to a tread surface of the wheel; and
moving the arms toward each other so that wheel rides up on rollers atop the arms, lifting the wheel, and during the lifting, the rollers urging the wheel toward an upright orientation.

2. The method of claim 1, where the arms roll upon wheels while moving toward each other.

3. The method of claim 1, where:
the arms include a substantially straight, telescoping member joining the arms;
a levered assembly is coupled to separate parts of the telescoping member;
the operations further comprise activating the levered assembly to adjust length of the telescoping member.

4. The method of claim 1, further comprising:
lowering the wheel by moving the arms away from each other, causing the rollers to rotate against the wheel.

5. A method of supporting a wheel of a vehicle, comprising operations of:
while a wheel is axially mounted to the vehicle and held in upright position, placing opposing arms of a substantially U-shaped bracket beneath the wheel on opposite sides thereof such that each arm is transverse to a tread surface of the wheel;
moving the arms toward each other so that wheel rides upon rollers atop the arms while the rollers support the wheel and urge the wheel toward an upright orientation; and
lowering the wheel by moving the arms away from each other, causing the rollers to rotate against the wheel.

6. The method of claim 5, where the arms ride upon wheels while moving toward each other.

7. The method of claim 5, where:
the arms include a substantially straight, telescoping member joining the arms;
a levered assembly is coupled to separate parts of the telescoping member;
the operations further comprise, before moving the arms toward each other, activating the levered assembly to adjust length of the telescoping member.

8. An apparatus for lifting wheels, comprising: p1 a substantially U-shaped bracket including opposing arms slidably interconnected to form a substantially straight center section, the bracket having upper and lower surfaces;
wheels attached to the lower surface;
affixed to the upper surface of each arm, at least one roller on each arm; where the rollers are arranged to cradle a round-edged wheel between the opposing arms and concurrently urge the wheel toward an upright position; a user-activated push/pull assembly attached to both arms to slidably lengthen and shorten the center section.

9. The apparatus of claim 8, the rollers on each arm including:
an inner roller assembly comprising one or more rollers having its outer end canted upward and also canted toward the opposite arm;
an outer roller assembly comprising one or more rollers having its outer end canted upward and also canted toward the opposite arm;
the inner and outer roller assemblies thereby forming a “V” shape in plan or end view.

10. The apparatus of claim 8, said at least one roller comprising:
a single roller having a convex rolling surface.

11. The apparatus of claim 8, said at least one roller comprising:
multiple rollers cooperatively arranged to form a receiving surface that is centrally rounded outward.

12. The apparatus of claim 8, the rollers including:
a pair of elongated rollers mounted end-to-end upon each respective arm;
where the rollers are canted in at least one of the following orientations:
each roller's outer end being nearer the opposing arm than the roller's inner end;
each roller's outer end being distanced from its respective arm more than the roller's inner end.

13. The apparatus of claim 8, the push/pull assembly comprising:
a lever having a proximal end pivotally coupled to a first one of the arms along the straight center section; and
a connecting rod pivotally coupled to a second one of the arms along the straight center section, and also coupled to a the lever distally from the proximal end.

14. The apparatus of claim 8, where:
the center section includes slidably interconnected first and second members;
the push/pull assembly comprises:
a lever having distal and proximal ends, the proximal end rotatably coupled to the first member; and
a connecting rod coupled between the second member and a point on the lever between the proximal and distal ends, the connecting rod including first and second threadably interconnected shafts, where coupling to the lever facilitates rotation of one of the and second shafts relative to the other.

15. The apparatus of claim 13, where the connecting rod is adjustable in length.

16. A wheel lifting device, comprising:
a cradle including a pair of substantially parallel arms interconnected by a center section of adjustable length;
on each arm, outer and inner roller assemblies, each roller assembly having a proximal and distal end, where:
the distal end of each outer roller assembly being elevated and canted toward the opposing arm with respect to the proximal end of the same outer roller assembly;
the proximal end of each inner roller assembly being elevated and canted toward the opposing arm with respect to the distal end of the same inner roller assembly; and
an adjustment handle coupled to the center section to adjust the length of the center section.

17. An apparatus for lifting wheels, comprising:
a substantially U-shaped bracket including opposing arms slidably interconnected to form a substantially straight center section, the bracket having upper and lower surfaces;
means for supporting the bracket above a floor while allowing movement of the bracket about the floor;
affixed to the upper surface of each arm,
on each arm, roller means for cradling a round-edged wheel between opposing arms and urging the wheel toward an upright position while allowing rotational movement of the wheel;
a user-activated push/pull means for slidably lengthening and shortening the center section.
